(19) United States
(12) Patent Application Publication
(10) Pub. No.: US 2003/0042112 A1
(43) Pub. Date: Mar. 6, 2003

(54) Vibratory part feeding system

(76) Inventors: Klaus D. Woerner, Cambridge (CA); Robert A. Kinsie, Kitchener (CA); Jeffrey C. Perkins, Cambridge (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/230,293

(22) Filed: Aug. 29, 2002

Related U.S. Application Data
(60) Provisional application No. 60/316,015, filed on Aug. 31, 2001.

(51) Int. Cl. B65G 47/12

(52) U.S. Cl. 198/446

(57) ABSTRACT

A part supply step feeder or flighted belt conveyor lifts parts from a hopper in a metered fashion to a transfer area, and there supplies parts to a vibratory feeder, which carries the parts from the transfer area through orientation features to an output end. If a part does not achieve the correct orientation before reaching the output end, then at some point it is rejected, passively or actively, preferably back to the part supply hopper, by gravity or by a conveyor, for example.

### REFERENCE TO RELATED APPLICATION

This is a formal application based on a United States provisional patent application, ser. No. 60/316,015, filed Aug. 31, 2001.

### BACKGROUND OF THE INVENTION

Vibratory feeders for parts are well-known, for example to feed individual parts to a work station in an automated assembly process. Typically the vibration is provided by a coil (i.e. electromagnet) mounted between a base and the vibrating platform, the vibration frequency being fixed, but the amplitude variable. Alternatively, the vibration may be created by an eccentric shaft or the like, in which case typically the amplitude is fixed, but the frequency may be varied by varying the motor speed and hence the shaft rpm. Various means may be employed to route parts to the vibratory feeder.

It is also known to have part orientation features combined with such feeders, such that the part is somehow correctly oriented as it moves forward under the influence of the vibration, and is ejected or otherwise removed if it is not correctly oriented. For example, the part may have to pass through an opening, or into a channel, or into a throat, or it may have to fall into a groove.

It is also known in part-handling to have various reject/eject mechanisms, to remove parts that are not properly positioned or oriented. Such mechanisms may include, for example, passive gates or projections or the like which deflect an improperly positioned or oriented part to a reject path, i.e. by the part coming into contact with something it would not contact if properly positioned or oriented, or may include detection by a suitable mechanical, electrical or optical means (for example a vision system), with active rejection by mechanical or pneumatic means, for example.

### SUMMARY OF THE INVENTION

Although aspects of the components of the invention are known, it is an object of the invention to provide a part feeding system which combines previously-known elements in a unique and particularly efficient manner, so as to produce part feeders having a variety of advantages over existing part feeders, including low cost, efficiency of operation, relatively low noise, and/or a relatively small footprint. Other advantages will be described or will become apparent in the course of the following detailed description.

In the invention, a part supply means, comprising a hopper and means for lifting parts from the hopper in a metered fashion to a transfer area, supplies parts to a vibratory feeder, which carries the parts from the transfer area through orientation features to an output end, where for example they may be picked up by a pick-and-place robot for assembly into a larger system. The pick-and-place robot or other means is not part of the present invention, i.e. the invention relates simply to moving the parts to the output area.

The part supply means, for example a step feeder or a flighted belt conveyor, may accomplish some preliminary orienting of the parts. For example, a step feeder may orient an elongated part, such as a bolt, so that it is aligned along a step, i.e. in one of two positions each 180 degrees apart. Final orientation is accomplished by the vibratory feeder, however, with the vibration inducing the parts to move to the proper orientation as they move along, through part-appropriate tooling. At some point along the vibratory feeder, if the part has still not achieved the correct orientation, then it is rejected, passively or actively, preferably back to the part supply hopper, by gravity or by a conveyor, for example.

Further features of the invention will be described or will become apparent in the course of the following detailed description.

### BRIEF DESCRIPTION OF THE DRAWINGS

The invention will now be described in greater detail with reference to the accompanying drawings of preferred embodiments, briefly described as follows:

FIG. 1 is a perspective view of a preferred embodiment of the overall system, using a flighted belt conveyor;

FIG. 2 is a rear side elevation view corresponding to FIG. 1;

FIG. 3 is a plan view corresponding to FIG. 1;

FIG. 4 is a cross-section of vibratory platform tooling and a reject chute of the FIG. 1 embodiment, showing an unrejected part;

FIG. 5 is a cross-section identical to FIG. 4, but showing rejected parts;

FIG. 6 is a perspective view of another preferred embodiment of the overall system, using a step feeder;

FIG. 7 is a cross-section of the step feeder, with its moving plates down;

FIG. 8 is a cross-section of the step feeder, with its moving plates down;

FIG. 9 is a plan view of another example, using a step feeder and two parallel part lines;

FIG. 10 is a cross-section showing the rejection means of the FIG. 9 embodiment;

FIG. 11 is a cross-section of the vibratory feeder portion of the FIG. 9 embodiment;

FIG. 12 is a perspective view illustrating optional control gates;

FIG. 13 is a perspective view of the vibratory feeder portion of the system; and

FIG. 14 is a side elevation view of the vibratory feeder.

### DETAILED DESCRIPTION

In the invention, the parts to be supplied by the system are deposited in quantity (manually by an operator, or by automated means) into a bin or hopper 1.

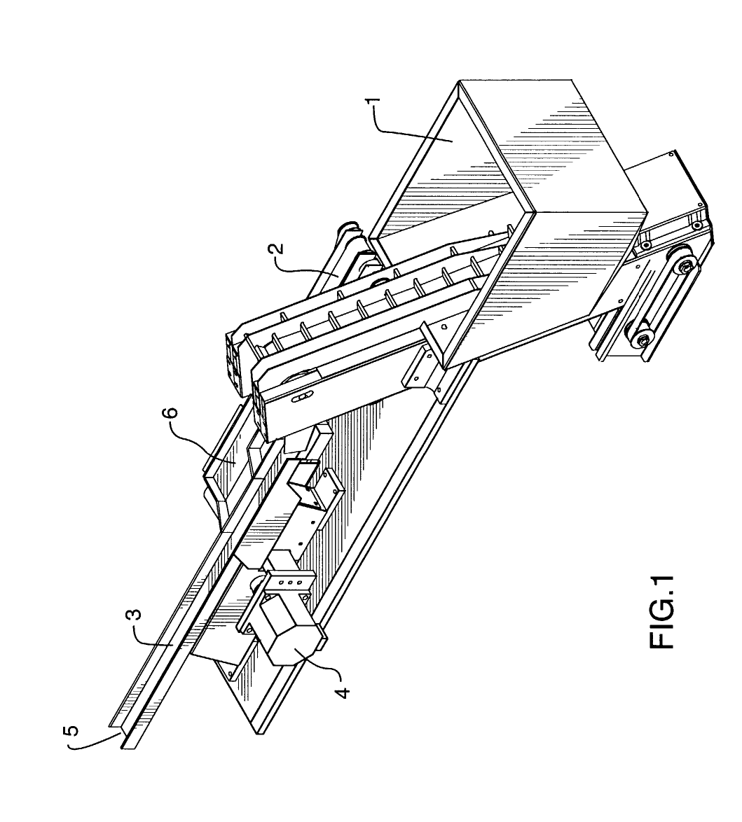

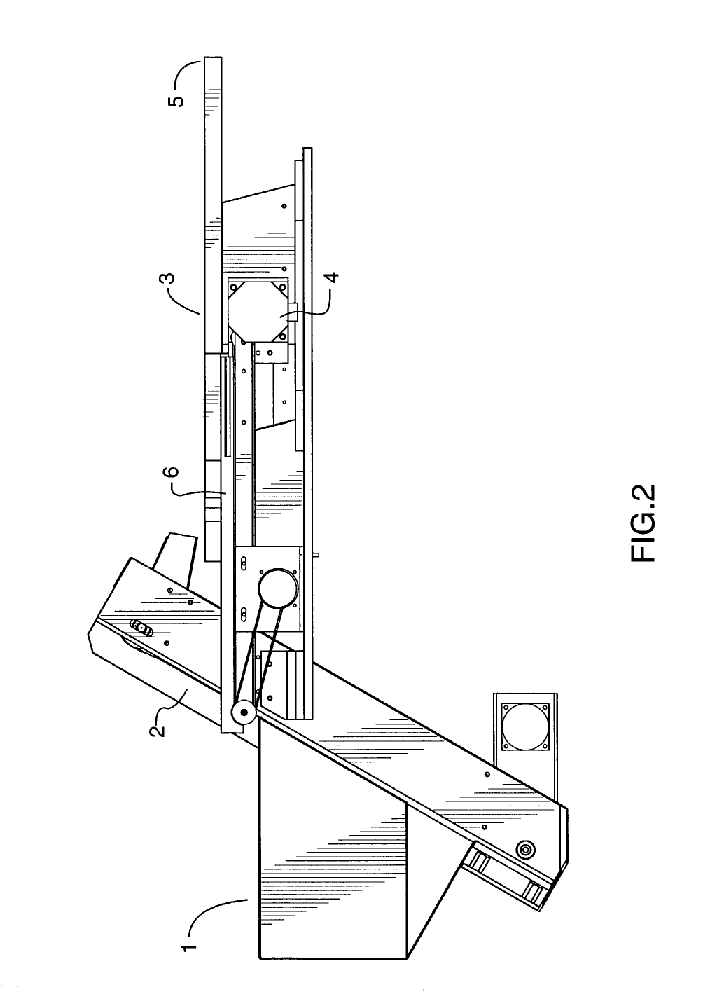

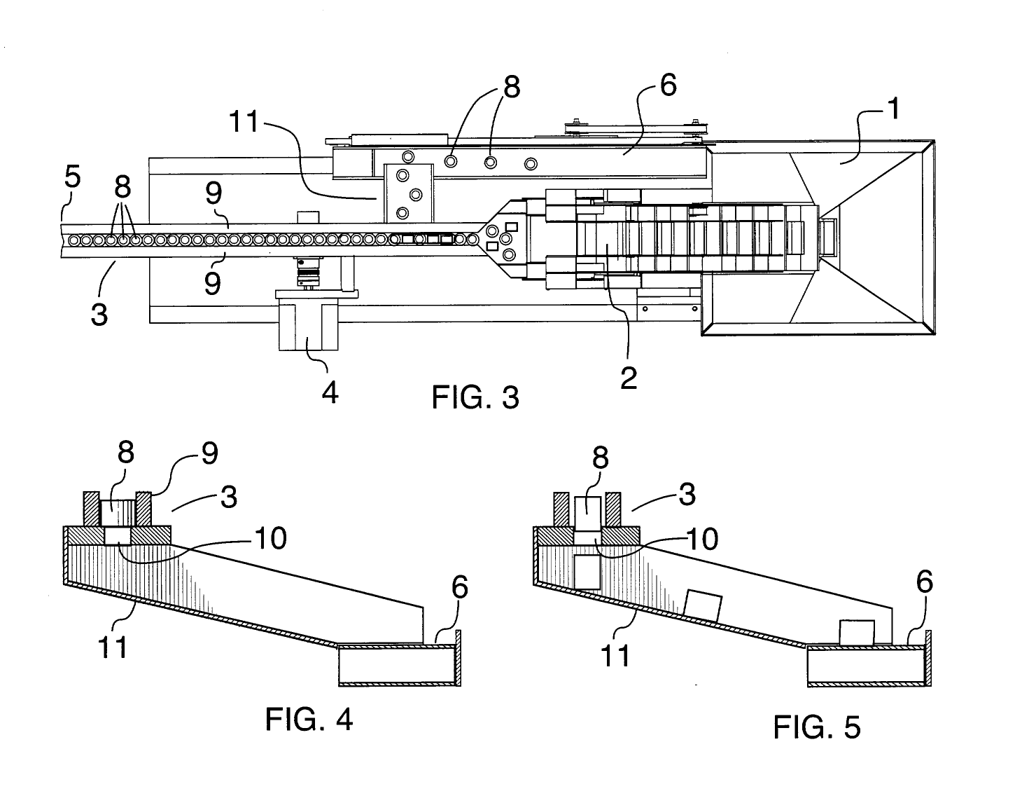

In one embodiment, as shown in FIGS. 1-3, a flighted belt conveyor 2 acts as a part supply means, to carry parts up from the hopper and deposit them at a controlled rate onto channelling means on the vibrating feeder platform 3. The vibration is produced by a motor 4, as will be described in more detail later. Parts are oriented properly as they move along the vibratory feeder towards an output end 5, where they are ready for any subsequent operation, for example pickup by a pick-and-place robot for assembly into a device passing by the system. Any parts which are not successfully oriented during their movement along the platform 3 are ejected and returned to the originating bin or hopper 1 by a return conveyor 6.

The rejection of parts may be accomplished by a wide variety of means. As discussed above, such means may include, for example, passive gates or projections or the like which deflect an improperly positioned or oriented part to a reject path, i.e. by the part coming into contact with something it would not contact if properly positioned or oriented, or may include detection by a suitable mechanical, electrical or optical means (for example a vision system), with active rejection by mechanical or pneumatic means. FIGS. 4 and 5 provide one example. In FIG. 4, the part 8 is properly oriented, and cannot fall through a reject opening 10. In FIG. 5, the part is shown incorrectly oriented, such that it falls through the opening 10 onto a reject chute 11, and thence onto the return conveyor 6. In some embodiments, the return may be entirely by gravity, i.e. if the hopper is lower than the reject area, while in other cases such as the one illustrated, a return conveyor may be required. In some cases, depending on the available space and necessary routing, more than one conveyor may be required, with one depositing rejected parts onto the next, i.e. if a convoluted path to the hopper is necessary.

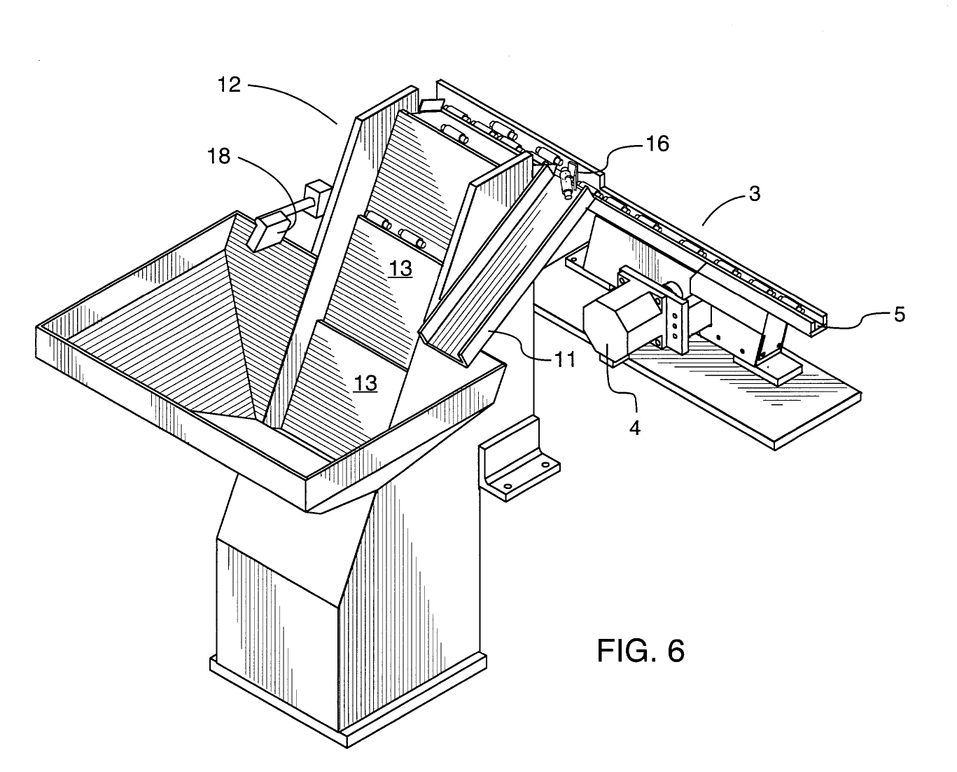

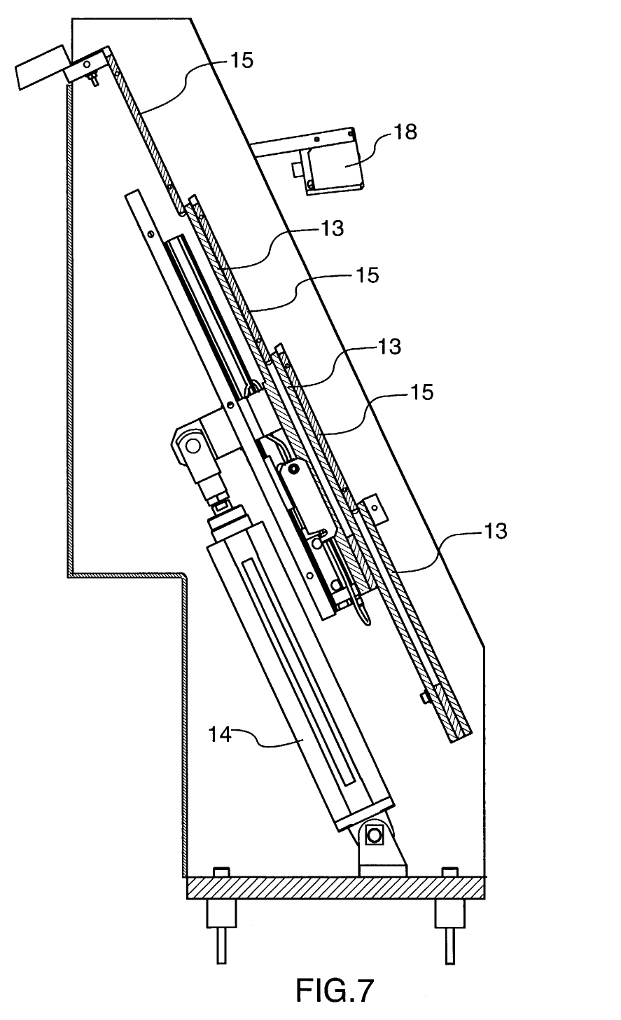

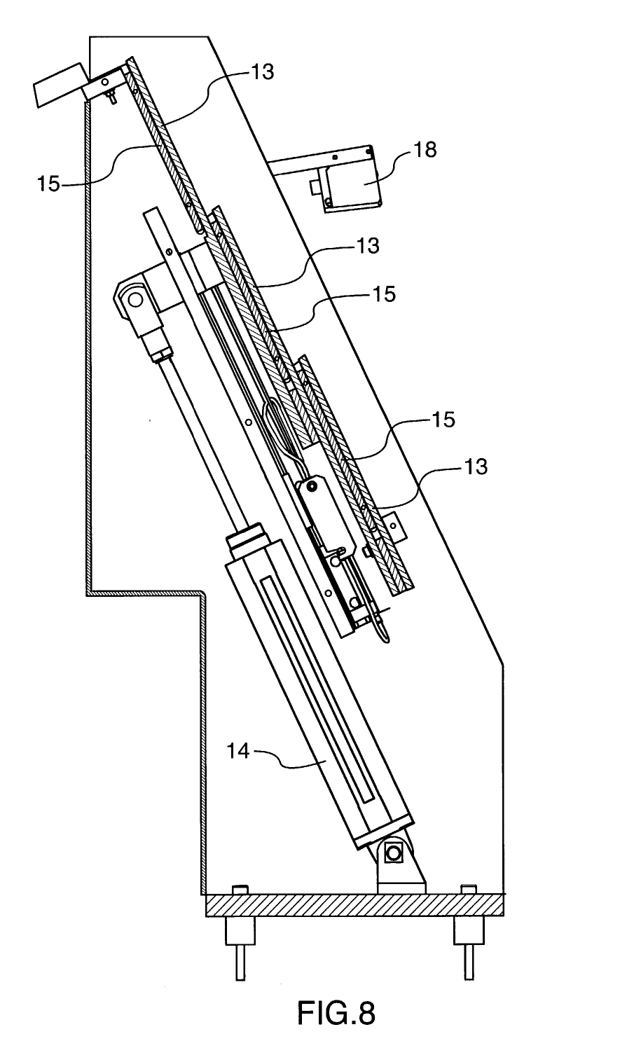

In another embodiment, as illustrated in FIGS. 6-8, instead of a flighted belt conveyor, a step feeder 12 is used to lift the parts from the hopper. The step feeder has several moving plates 13, cycled by a cylinder 14, which slide over fixed plates 15 to lift the parts in sequence from one level to another, as is known in step feeders. FIG. 7 shows the moving plates in their lowest position, and FIG. 8 shows them at their highest position, where they will have lifted a part to the fixed plate behind them.

The step feeder has the advantage, particularly with elongated parts, that preliminary orientation will be achieved automatically, thereby simplifying the orienting tasks of the vibratory feeder. Any elongated parts which are not aligned with the steps, i.e. in one of two positions 180 degrees from each other, will tend to fall off the steps. Thus, as shown in FIG. 6, they are likely to arrive at the vibratory feeder already oriented for a vibratory feeder extending parallel to the steps. FIG. 6 shows another example of a reject means for any parts 8′ which are not properly oriented. The improperly oriented parts will contact a deflector 16, which deflects them down a reject chute 11, back to the hopper. Correctly oriented parts will pass under the deflector.

FIG. 6 illustrates another advantageous feature of the system. An infrared beam and sensor 18 is positioned to direct an infrared beam down towards the bottom of the hopper. When the hopper is loaded, there generally will be no strong reflection back to the sensor. However, when the hopper is empty or nearly so, there will be a stronger reflection back to the sensor, which can be detected and hence used to trigger an alarm advising the operator to refill the hopper.

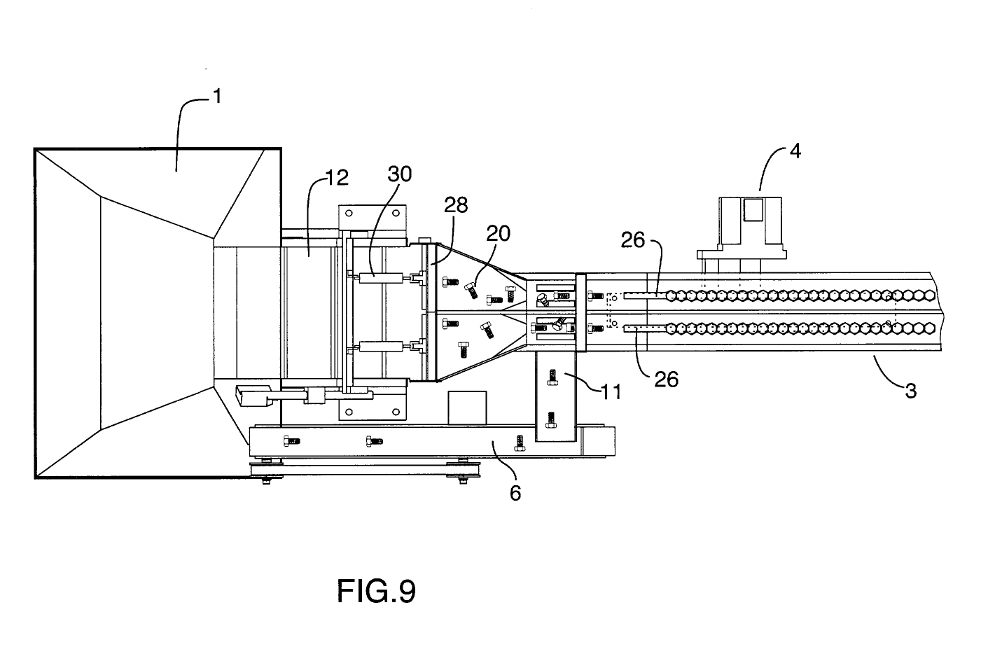

FIG. 9 illustrates another example of the invention, again using a step feeder 12, but having two parallel part supply lines, in this case extending at 90 degrees to the step feeder plates, i.e. straight out from the step feeder feed direction as seen from above. Obviously the directions could be changed at will according to the desired design and available space, though for convenience most designs will either be parallel to the step feeder or belt conveyer direction, or at 90 degrees thereto.

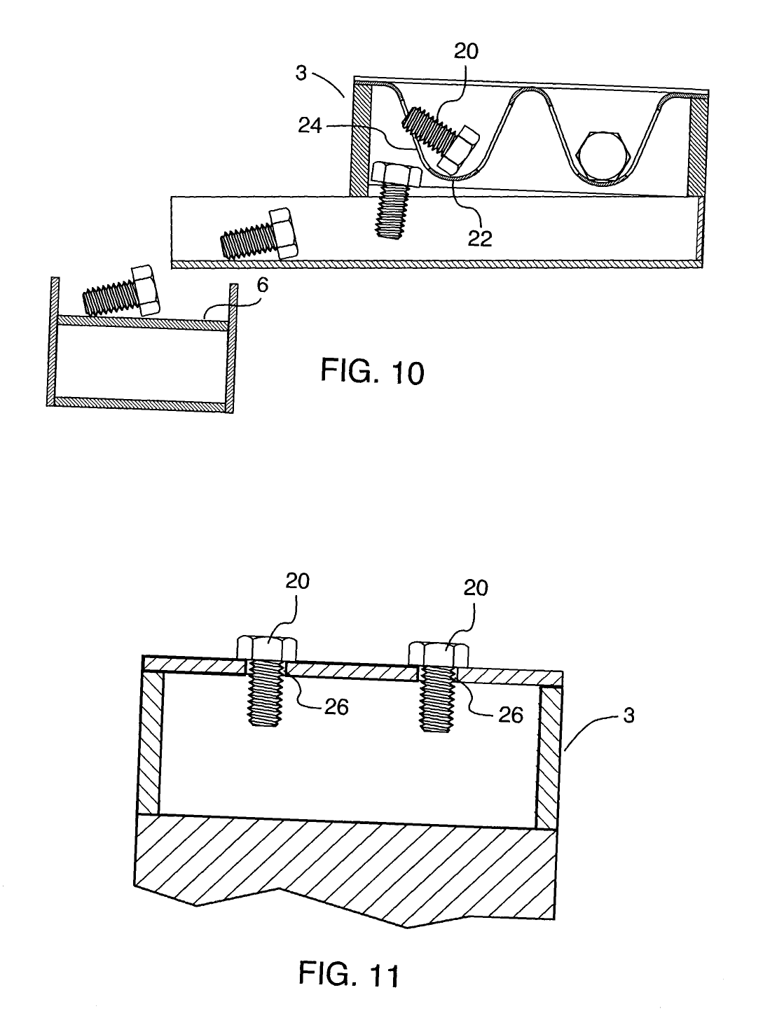

FIG. 10 shows another example of a reject mechanism, in this case for bolts 20. If the bolts are aligned axially, facing in one direction or 180 degrees opposite, they can move along the surface 22, but if they are not so aligned, they will fall through the openings 24 and onto the reject chute 11, and thence onto a return conveyor 6 to the hopper 1 (see FIG. 9). The bolts which pass through this area, whether facing in one direction or 180 degrees opposite, will move along and have their threaded ends fall through slots 26, the slots being wide enough for the shaft to fall through, but narrow enough to prevent the head from falling through, so that each bolt, regardless of its initial direction, is oriented vertically and head up.

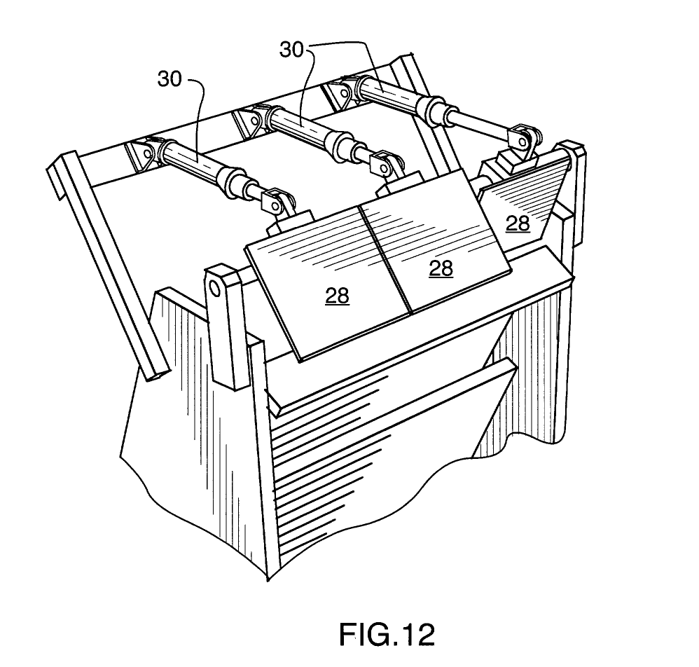

Preferably, as illustrated in FIGS. 9 and 12, since the step feeder will be operated at a higher speed to supply more parts than if there was only one parts line, control gates 28, operated by cylinders 30, are positioned to block or prevent flow into one or the other line, in case the step feeder randomly supplies too many parts to one line for it to handle. Any suitable detection means can be used to sense an overload, whereupon the appropriate cylinder can be actuated to momentarily stop the flow until the system can catch up.

It should be clear that there could easily be more than two lines (parallel or otherwise), being supplied by the same step feeder or belt conveyor, each with its own control gate. Three gates are shown in FIG. 12, for example. Parallel lines could be mounted on the same vibrating platform, as shown, or there could be separate vibrating platforms.

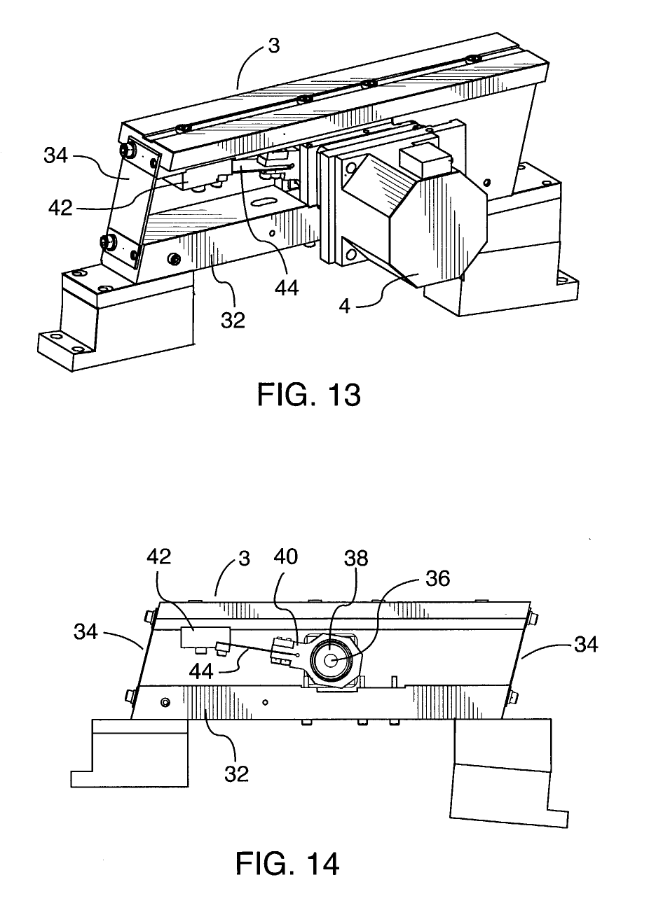

Turning now to the vibratory feeder portion of the system, it could be a conventional (coil-type) vibratory in-line feeder, or alternatively, as in the preferred embodiment, it could be a motor-driven in-line feeder. The preferred embodiment is illustrated in FIGS. 13-14. The platform 3 (shown without tooling, i.e. with no part channelling means mounted on its upper surface, as required for part handling) vibrates by virtue of being mounted above a stationary base 32 by leaf springs 34 at opposite ends thereof. A variable-speed motor 4 which drives a shaft 36 which is mounted in a slightly eccentric bearing 38 mounted in a bearing block 40 connected to a vibration block 44 on the underside of the platform via another leaf spring 44. Obviously a number variations of the actual design are possible.

Although the coil-type vibratory feeder is generally less expensive, and may be employed, the motor-driven type has the advantage of being generally quieter, with less extraneous vibration, and a generally greater load capacity for heavier parts. The motor will typically be driven at around 2500 rpm, though obviously that may be varied as desired for optimum performance.

Particularly from looking at a plan view of the system, it can be seen that the footprint of the system is very small, especially when compared to conventional bowl feeders. In general, the system provides cost-effective and highly flexible, high-performance part feeding.

1. A part feeding system, comprising:
a part supply means, comprising a hopper into which bulk parts may be placed by an operator and means for lifting said parts from the hopper in a metered fashion to a transfer area; and
a vibratory feeder comprising a vibrating conveying platform positioned to receive parts at said transfer area, adjacent an input end, and to convey said parts to an output end, said vibratory feeder comprising means for urging said parts to a desired orientation prior to reaching said output end.

2. A part feeding system as in claim 1, further comprising means for routing parts which do not achieve said desired orientation back to said hopper.

3. A part feeding system as in claim 1, wherein said means for lifting parts in said part supply means comprises a step feeder.

4. A part feeding system as in claim 1, wherein said means for lifting parts in said part supply means comprises a flighted belt conveyor.

5. A part feeding system as in claim 1, wherein said vibratory feeder is of the electromagnetic coil type.

6. A part feeding system as in claim 1, wherein said vibratory feeder is of the type comprising a motor and an eccentric.

7. A part feeding system as in claim 6, wherein said vibratory feeder has a platform mounted above a base by leaf springs adjacent opposite ends thereof, a motor mounted to said base driving a eccentric means, said eccentric means connected to said platform via a further leaf spring so as to convert eccentric motion into vibratory motion of said platform.

8. A part feeding system as in claim 6, further comprising means for routing parts which do not achieve said desired orientation back to said hopper.

9. A part feeding system as in claim 6, wherein said means for lifting parts in said part supply means comprises a step feeder.

10. A part feeding system as in claim 6, wherein said means for lifting parts in said part supply means comprises a flighted belt conveyor.
